(19) United States
(12) Patent Application Publication
(10) Pub. No.: US 2013/0088751 A1
(43) Pub. Date: Apr. 11, 2013

(54) JOB MANAGEMENT APPARATUS, JOB CONTROL SYSTEM, AND JOB CONTROL METHOD

(71) Applicant: Tomoki YOSHIDA, Kanagawa (JP)

(72) Inventor: Tomoki YOSHIDA, Kanagawa (JP)

(73) Assignee: RICOH COMPANY, LTD., Tokyo (JP)

(21) Appl. No.: 13/632,249

(22) Filed: Oct. 1, 2012

(30) Foreign Application Priority Data
Oct. 7, 2011 (JP) 2011-222619

(51) Int. Cl. G06K 15/02

(52) U.S. Cl. 358/1.15

(57) ABSTRACT

A job management apparatus is connected via an external network to a job control apparatus in a first network and an information processing apparatus in a second network that is different from the first network. The job control apparatus is configured to send a job to an execution apparatus that is in the first network and executes the job. The job management apparatus includes a receiving unit configured to receive jobs from the information processing apparatus; and a management unit configured to temporarily store the received jobs in a storage area in association with execution areas where the jobs are to be executed and to send, to the job control apparatus, one or more of the jobs associated with an execution area corresponding to an installation area where the job control apparatus is installed in response to a request from the job control apparatus.

### CROSS-REFERENCE TO RELATED APPLICATION

The present application is based upon and claims the benefit of priority of Japanese Patent Application No. 2011-222619, filed on Oct. 7, 2011, the entire contents of which are incorporated herein by reference.

### BACKGROUND OF THE INVENTION

1. Field of the Invention

An aspect of this disclosure relates to a job management apparatus, a job control system, and a job control method.

2. Description of the Related Art

Japanese Laid-Open Patent Publication No. 2008-217718, for example, discloses a print control system where a print control apparatus such as a print server stores print jobs sent from information processing apparatuses such as personal computers (PC) for respective users; and an image processing apparatus such as a printer performs user authentication, obtains a print job specified by an authorized user from the print control apparatus, and prints the obtained print job.

Thus, in the disclosed print control system, user authentication is employed in print job storing and obtaining processes to provide a secure printing service.

With the disclosed technology, however, printing can be requested only from apparatuses that can access (or are allowed to connect to) the print control apparatus.

A print control apparatus is generally connected to a private network such as a local area network to maintain security. For this reason, a print control apparatus connected to a network accepts requests to store and obtain print jobs only from information processing apparatuses and image processing apparatuses that are connected to the same network (i.e., accepts only accesses from internal apparatuses). Meanwhile, due to the globalization of business, there is demand for a printing service that can be used in a wide area. For example, it is desired to use a printing service provided by a print control apparatus located in an office from an information processing apparatus (external apparatus) that is located in a different office and cannot access (or is not allowed to connect to) the print control apparatus.

### SUMMARY OF THE INVENTION

In an aspect of this disclosure, there is provided a job management apparatus that is connected via an external network to a job control apparatus in a first network and an information processing apparatus in a second network that is different from the first network. The job control apparatus is configured to send a job to an execution apparatus that is in the first network and executes the job. The job management apparatus includes a receiving unit configured to receive jobs from the information processing apparatus; and a management unit configured to temporarily store the received jobs in a storage area in association with execution areas where the jobs are to be executed and to send, to the job control apparatus, one or more of the jobs associated with an execution area corresponding to an installation area where the job control apparatus is installed in response to a request from the job control apparatus.

### BRIEF DESCRIPTION OF THE DRAWINGS

FIG. 1 is a drawing illustrating an exemplary configuration of a print control system according to an embodiment;

FIG. 2 is a block diagram illustrating an exemplary hardware configuration of a server according to an embodiment;

FIG. 3 is a block diagram illustrating an exemplary functional configuration of a print control system according to an embodiment;

FIG. 4 is a drawing illustrating an exemplary log-in screen;

FIG. 5 is a drawing illustrating an exemplary print-area specification screen;

FIG. 6 is a table illustrating exemplary management information;

FIG. 7 is a table illustrating exemplary print job information;

FIG. 8 is a drawing illustrating an exemplary print-job selection screen;

FIG. 9 is a sequence chart illustrating an exemplary print control process (1);

FIG. 10 is a sequence chart illustrating an exemplary print control process (2);

FIG. 11 is a table illustrating an exemplary change (1) made to management information;

FIG. 12 is a sequence chart illustrating an exemplary print control process (3);

FIG. 13 is a table illustrating an exemplary change (2) made to management information; and

FIG. 14 is a sequence chart illustrating an exemplary print control process (4).

### DESCRIPTION OF THE PREFERRED EMBODIMENTS

Preferred embodiments of the present invention are described below with reference to the accompanying drawings.

### <System Configuration>

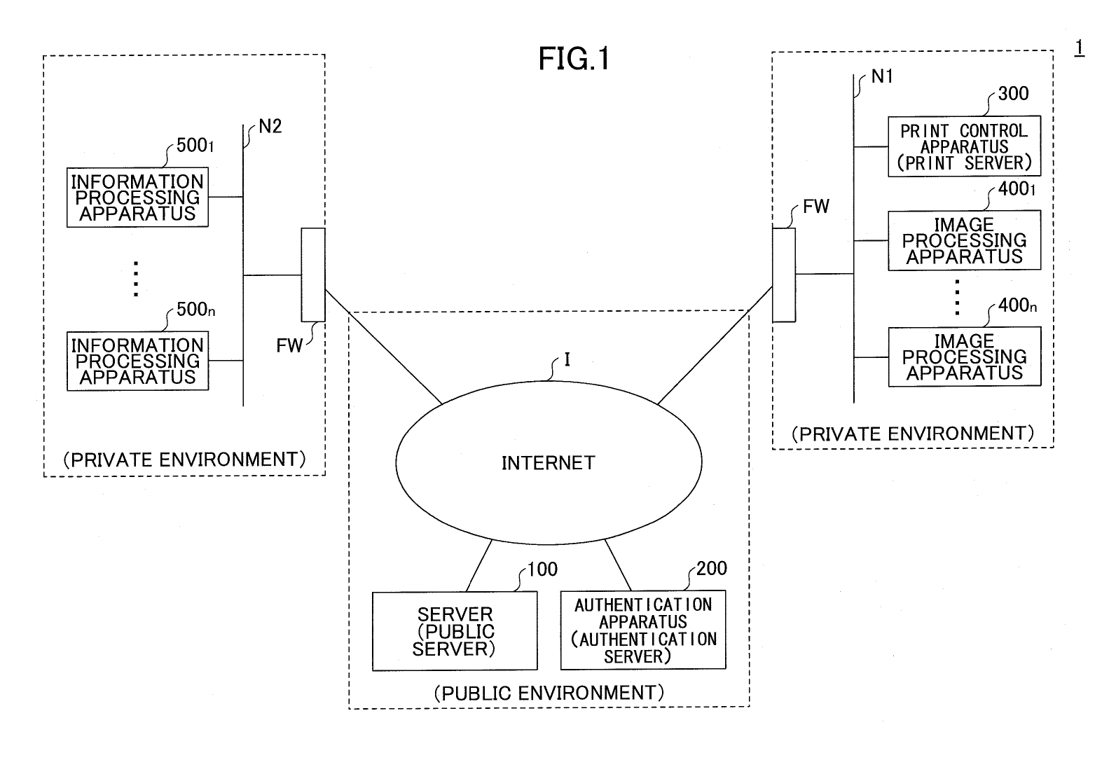

FIG. 1 is a drawing illustrating an exemplary configuration of a print control system 1 according to an embodiment.

As illustrated in FIG. 1, the print control system 1 may include a server 100 and an authentication apparatus 200 that are connected to an external network I, such as the Internet, in a public environment.

The print control system 1 may also include a print control apparatus 300 and one or more image processing apparatuses 400₁ through 400ₙ (which hereinafter may be referred to as the image processing apparatuses 400 or the image processing apparatus 400 for descriptive purposes) connected to an internal network N1, such as a LAN, in a private environment. The print control system 1 may further include one or more information processing apparatuses 500₁ through 500ₙ (which hereinafter may be referred to as the information processing apparatuses 500 or the information processing apparatus 500 for descriptive purposes) connected to an internal network N2, such as a LAN, in a private environment. For example, the internal networks N1 and N2 are located in different offices and not mutually accessible (not allowed to connect to each other).

In the example of FIG. 1, the internal networks N1 and N2 are connected via firewalls FW to the external network I. That is, it is possible to access the external network I from the internal networks N1 and N2, and it is possible to respond, via the external network I, to requests from the internal networks N1 and N2.

The server 100 is, for example, a public server that is accessible from external apparatuses and manages data received from the external apparatuses. The authentication apparatus 200 is, for example, an authentication server that is accessible from external apparatuses and includes an authentication function for performing user authentication.

The print control apparatus 300 is, for example, a print server that is accessible from internal apparatuses and includes a print control function for managing print jobs. The image processing apparatus 400 is, for example, a printer or a multifunction peripheral (MFP) that includes image processing functions such as a printing function. The information processing apparatus 500 is, for example, a personal computer (PC) used as a user terminal and includes information processing functions.

The print control system 1 of the present embodiment provides a printing environment as described below. In the descriptions below, it is assumed that print jobs sent from the information processing apparatuses 500 connected to the internal network N2 are printed (or executed) on the image processing apparatuses 400 connected to the internal network N1.

After user authentication by the authentication apparatus 200, the information processing apparatus 500 displays an operation screen used by the user to select or enter a print job, and sends data including the selected/entered print job to the server 100. The server 100 receives the data and temporarily stores the received data in a predetermined storage area.

The print control apparatus 300 requests a print job from the server 100. In response, the server 100 sends the requested print job, which is temporarily stored in the server 100, to the print control apparatus 300. The print control apparatus 300 receives the print job and stores the received print job in a predetermined storage area.

After user authentication by the authentication apparatus 200, the image processing apparatus 400 requests the print job from the print control apparatus 300 and prints (or executes) the print job received from the print control apparatus 300.

Thus, in the print control system 1 of the present embodiment, print jobs are sent and received between apparatuses connected to different internal networks N via the server 100 connected to the external network I. This configuration enables the information processing apparatus 500 to use a printing service of the print control apparatus 300 that the information processing apparatus 500 cannot access (or is not allowed to connect to).

The information processing apparatus 500 is not limited to a PC, but may be implemented by any apparatus that can send a print job. For example, the information processing apparatus 500 may be implemented by a smartphone, a tablet PC, a projector, or a media board.

The information processing apparatus 500 may not necessarily be connected to the internal network N2. In the present embodiment, it is assumed that the information processing apparatus 500 cannot access (or is not allowed to connect to) the print control apparatus 300. As long as this assumption is satisfied, the information processing apparatus 500 may be connected to the external network I.

### <Hardware Configuration>

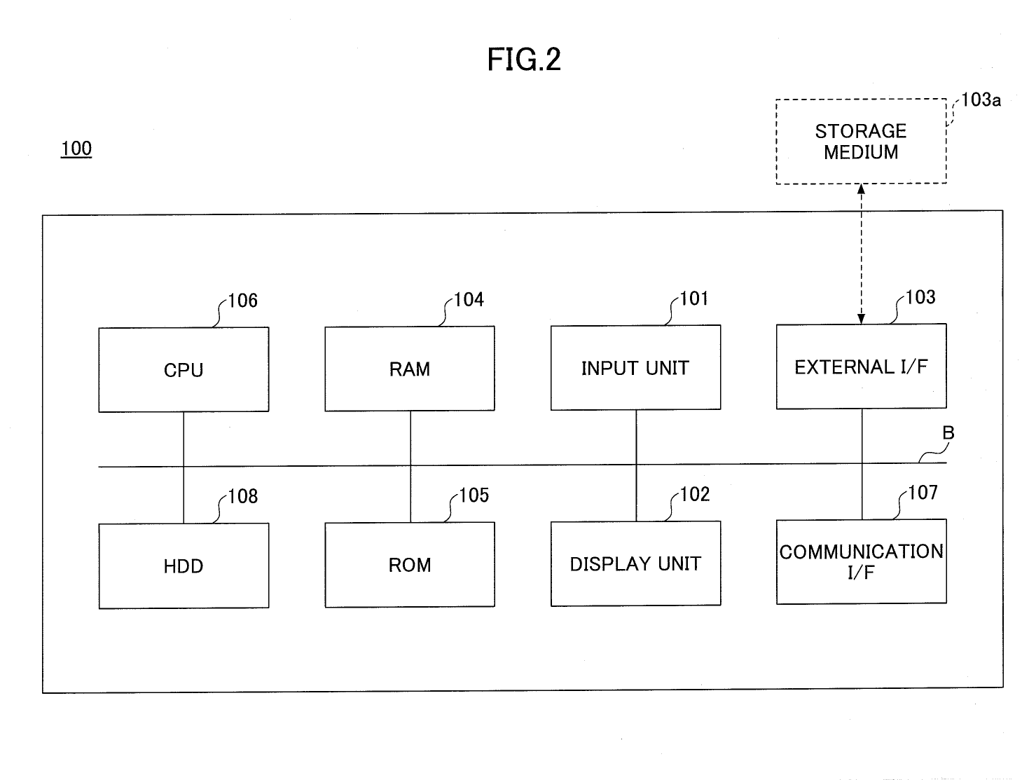

FIG. 2 is a block diagram illustrating an exemplary hardware configuration of the server 100.

As illustrated in FIG. 2, the server 100 may include an input unit 101, a display unit 102, an external I/F 103, a random access memory (RAM) 104, a read only memory (ROM) 105, a central processing unit (CPU) 106, a communication I/F 107, and a hard disk drive (HDD) 108 that are connected to each other via a bus B.

The input unit 101 includes, for example, a keyboard and a mouse, and is used to input instructions (or operation signals) to the server 100. The, display unit 102 displays, for example, processing results of the server 100.

The communication I/F 107 is an interface for connecting the server 100 to a network (e.g., the external network I). The server 100 can perform data communications with other apparatuses (e.g., the authentication apparatus 200, the print control apparatus 300, the image processing apparatuses 400, and the information processing apparatuses 500) via the communication I/F 107.

The HDD 108 is a non-volatile storage medium for storing various programs and data. For example, the HDD 108 stores basic software or an operating system (OS) for controlling the entire server 100, and applications for providing various functions on the OS. The HDD 108 may manage the stored programs and data using a file system and/or a database (DB).

The external I/F 103 is an interface between the server 100 and an external device such as a storage medium 103a. The server 100 can read and write data from and to the storage medium 103a via the external I/F 103. Examples of the storage medium 103a include a floppy (flexible) disk (FD), a compact disk (CD), a digital versatile disk (DVD), a secure digital (SD) memory card, and a universal serial bus (USB) memory.

The ROM 105 is a non-volatile semiconductor memory (storage unit) that can retain data even when power is turned off. For example, the ROM 105 stores programs and data such as a basic input/output system (BIOS) that is executed when the server 100 is turned on, and system and network settings of the server 100. The RAM 104 is a volatile semiconductor memory (storage unit) for temporarily storing programs and data. The CPU 106 loads programs and data from storage units (e.g., the HDD 108 and the ROM 105) into the RAM 104 and executes the loaded programs to control the server 100 and to implement various functions.

With the above hardware configuration, the server 100 can provide various information processing functions (information processing services) including a print control function.

### <Print Control Function>

A print control function according to an embodiment is described below.

In the print control system 1 of the present embodiment, the server 100 is connected to the external network I (or provided in a public environment) that is accessible to external apparatuses. The server 100 temporarily stores print jobs, which are sent from the information processing apparatuses 500 that cannot access (or are not allowed to connect to) the print control apparatus 300, in a predetermined storage area, and manages the stored print jobs in association with information (hereafter referred to as “print area information”) indicating areas where users desire to print (or execute) the print jobs. The print area information is specified by the respective users when sending the print jobs. The print control apparatus 300 sends information (hereafter referred to as “installation area information”) indicating an area where the print control apparatus 300 is installed (or located) to the server 100 and thereby requests print jobs from the server 100. Through this process, the print control apparatus 300 obtains, from the server 100, print jobs associated with print area information corresponding to its own installation area information, and stores the obtained print jobs in a predetermined storage area. This configuration enables the image processing apparatuses 400 that can access the print control apparatus 300 to obtain print jobs from the print control apparatus 300 and print (or execute) the print jobs. The print control system 1 of the present embodiment provides a print control function as described above.

With related-art print control systems, printing can be requested only from apparatuses that are allowed to access (or connected to the same network as) the print control apparatus 300.

To solve the above problem in related-art print control systems, the print control system 1 of the present embodiment is configured such that the server 100, which is accessible to external apparatuses, temporarily stores print jobs sent from the information processing apparatuses 500 that cannot access (or are not allowed to connect to) the print control apparatus 300, and the print control apparatus 300 obtains print jobs from the server 100 and stores the obtained print jobs.

This configuration enables the information processing apparatuses 500 to use a printing service of the print control apparatus 300 that the information processing apparatuses 500 are not allowed to access.

An exemplary functional configuration of the print control system 1 is described below.

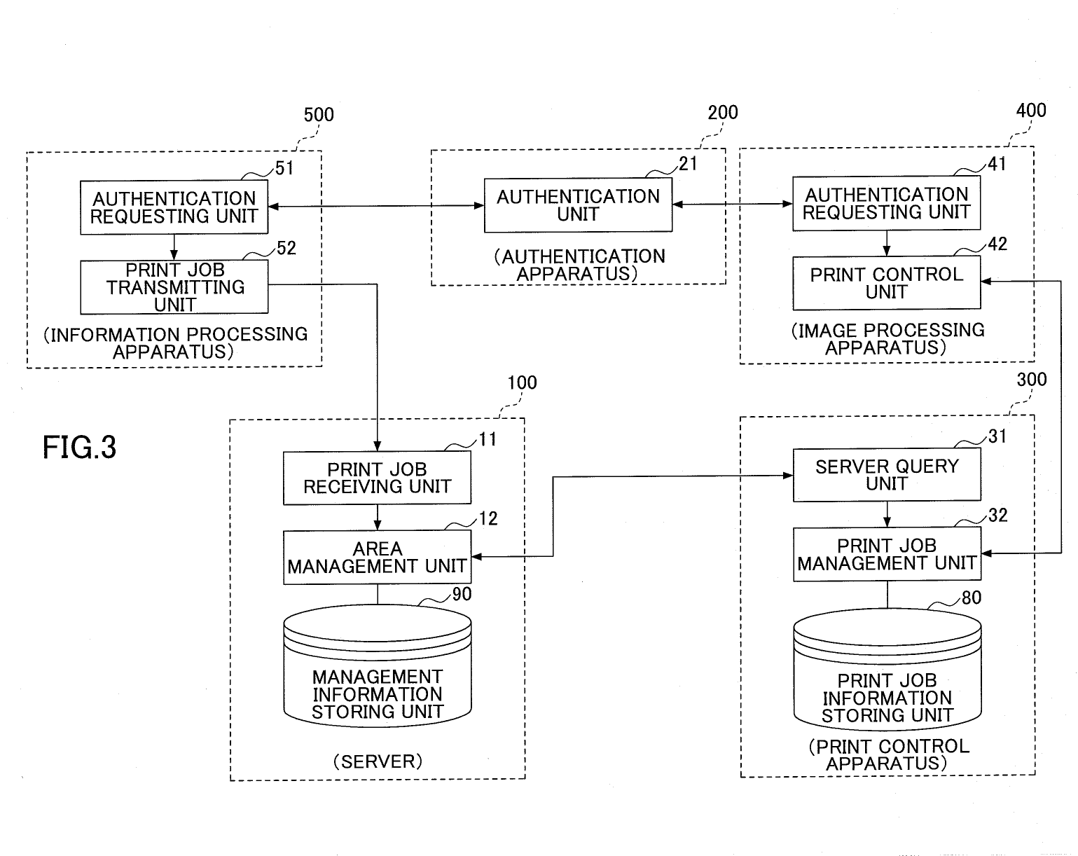

FIG. 3 is a block diagram illustrating an exemplary functional configuration of the print control system 1 of the present embodiment.

As illustrated in FIG. 3, the print control system 1 includes a print job receiving unit 11, an area management unit 12, an authentication unit 21, a server query unit 31, a print job management unit 32, an authentication requesting unit 41, a print control unit 42, an authentication requesting unit 51, and a print job transmitting unit 52.

The print job receiving unit 11 and the area management unit 12 are functional units of the server 100. The authentication unit 21 is a functional unit of the authentication apparatus 200. The server query unit 31 and the print job management unit 32 are functional units of the print control apparatus 300. The authentication requesting unit 41 and the print control unit 42 are functional units of the image processing apparatus 400. The authentication requesting unit 51 and the print job transmitting unit 52 are functional units of the information processing apparatus 500.

A print control function of the present embodiment is provided through collaboration of the above described functional units.

### <Information Processing Apparatus>

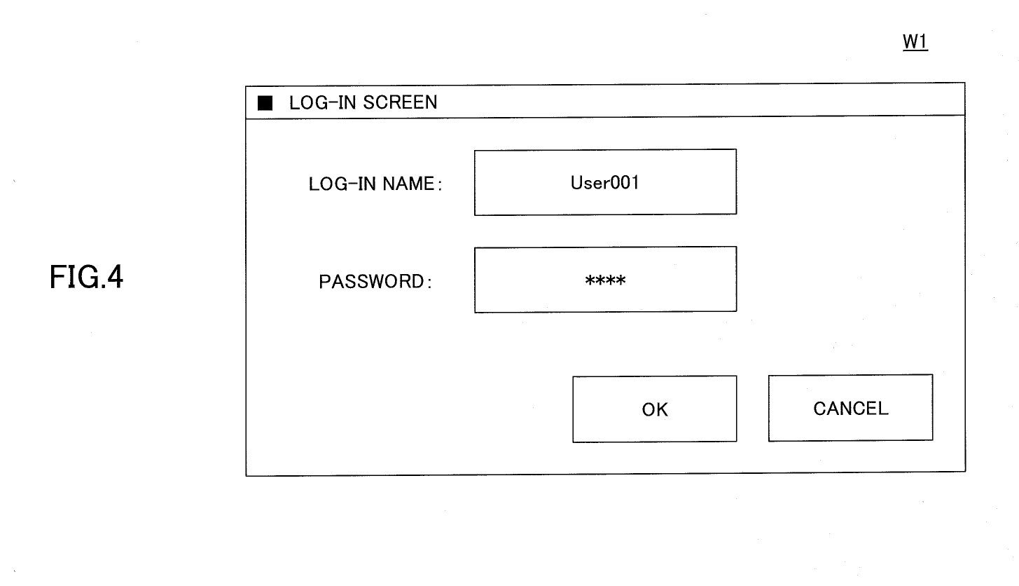

The authentication requesting unit 51 is a functional unit that requests user authentication. The authentication requesting unit 51, for example, displays a log-in screen W1 as illustrated in FIG. 4.

FIG. 4 is a drawing illustrating an example of the log-in screen W1.

As illustrated in FIG. 4, the log-in screen W1 allows the user to enter a log-in name (user identification information) for identifying the user and a password (authentication information) for authenticating the user. The authentication requesting unit 51 receives the log-in name and the password as user information (log-in information).

Referring back to FIG. 3, the authentication requesting unit 51 sends the received user information to the authentication apparatus 200 to request user authentication. Then, the authentication requesting unit receives an authentication result from the authentication apparatus 200 and determines whether the user is an authorized user based on the authentication result.

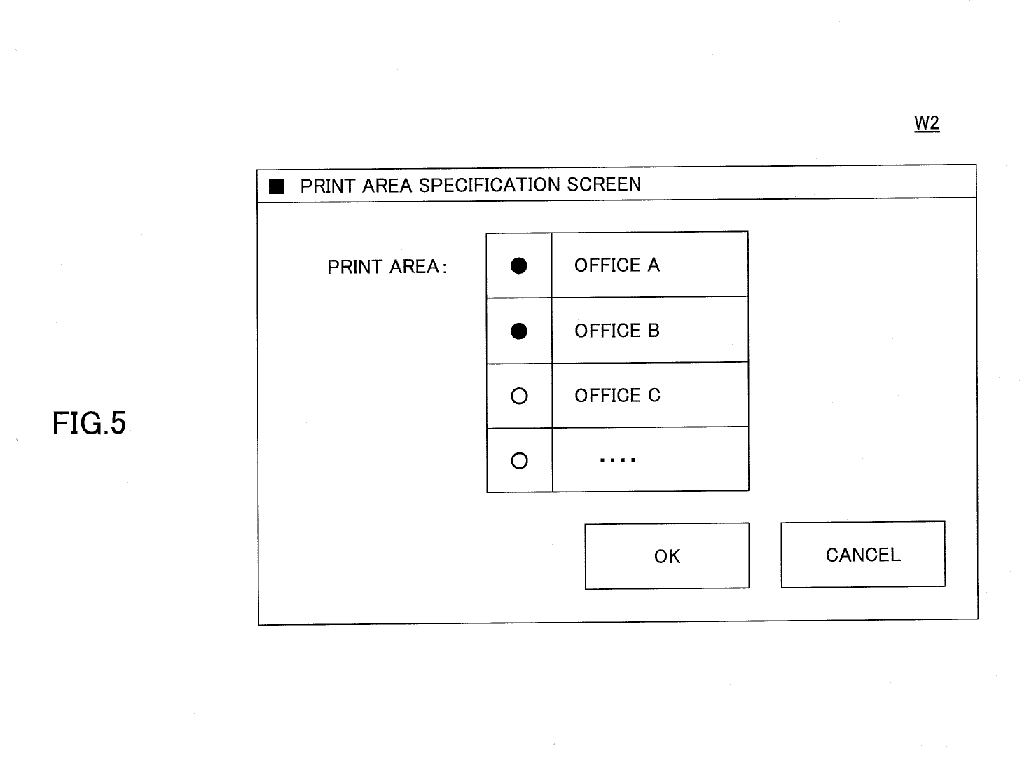

The print job transmitting unit 52 is a functional unit that sends a print job. When the user is an authorized user, the print job transmitting unit 52, for example, displays a print area specification screen W2 as illustrated in FIG. 5.

FIG. 5 is a drawing illustrating an example of the print area specification screen W2.

As illustrated in FIG. 5, the print area specification screen W2 allows the user to specify one or more areas (hereafter referred to as “print areas”) where the user desires to print (or execute) the print job. The print job transmitting unit 52 receives the specified print areas as print area information. Print areas are represented by, for example, office names. In the example of FIG. 5, office A and office B are specified as print areas.

Referring back to FIG. 3, the print job transmitting unit 52 also displays an operation screen (not shown) that displays identification information (job identification information) of print jobs and allows the user to select a print job. The print job transmitting unit 52 sends data including the selected print job (print data) and the specified print area information to the server 100. When sending the print job and the print area information, the print job transmitting unit 52 may also send the user identification information of the authorized user, the job identification information of the print job, and a bibliography obtained from print conditions set in the print job.

### <Server>

The print job receiving unit 11 is a functional unit that receives print jobs. The print job receiving unit 11 receives the data including the print job and the print area information that are sent from the print job transmitting unit 52 of the information processing apparatus 500.

The area management unit 12 is a functional unit that manages print areas. The area management unit 12 temporarily stores print jobs received from the information processing apparatuses 500 in a predetermined storage area of a storage unit of the server 100, and manages the print jobs using management information 90D that associates the print jobs with print area information specified for the print jobs.

The management information 90D is described below.

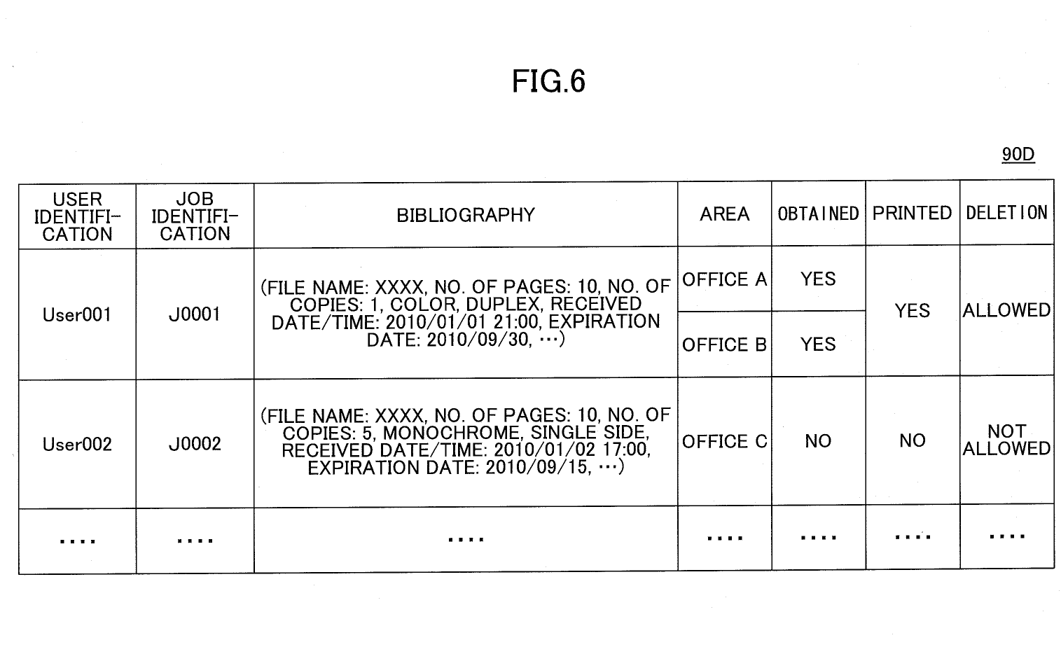

FIG. 6 is a table illustrating an example of the management information 90D.

As illustrated in FIG. 6, the management information 90D may include an information set for each user. The information set may include “user identification”, “job identification”, “bibliography”, “area”, “obtained”, “printed”, and “deletion” fields that are associated with each other.

The “user identification” field stores user identification information (e.g., a user ID) for uniquely identifying a user. The “job identification” field stores job identification information (e.g., a job ID) for uniquely identifying a print job. The “bibliography” field stores bibliographic information including, for example, a file name of a print job; the number of pages; print conditions such as the number of copies, a color/monochrome setting, and a duplex/single-side setting; the date and time the print job is received; and an expiration date.

The “area” field stores print area information that is, for example, an identifier (such as an office name or a network area name) for uniquely identifying a print area. The “obtained” field stores information (hereafter referred to as “acquisition status information”) indicating whether the corresponding print job has been obtained by the print control apparatus 300. In this example, “NO” indicates that the print job has not been obtained yet by the print control apparatus 300, and “YES” indicates that the print job has been obtained by the print control apparatus 300. The “printed” field stores information (hereafter referred to as “print status information”) indicating whether the corresponding print job has been printed by one of the image processing apparatuses 400. In this example, “NO” indicates that the print job has not been printed yet, and “YES” indicates that the print job has been printed. The “deletion” field stores information (hereafter referred to as “deletion control information”) indicating whether deletion of the corresponding print job from the print control apparatus 300 is allowed. In this example, “ALLOWED” indicates that deletion of the print job is allowed, and “NOT ALLOWED” indicates that deletion of the print job is not allowed.

The management information 90D is stored and retained in a management information storing unit 90 that is implemented by a storage area of a storage unit of the server 100.

Referring again to FIG. 3, the area management unit 12 registers the management information 90D as described below.

When receiving data including a print job, print area information, user identification information, job identification information, and so on from the information processing apparatus 500, the area management unit 12 accesses the management information storing unit 90, generates a new information set based on the received data, and registers the generated information set in the management information 90D. More specifically, the area management unit 12 refers to the management information 90D based on the user identification information or the job identification information in the received data. When no information set corresponding to the user identification information or the job identification information is present in the management information 90D, the area management unit 12 generates a new information set by registering the user identification information, the job identification information, the bibliographic information, and the print area information obtained from the received data in the “user identification”, “job identification”, “bibliography”, and “area” fields. In the “obtained”, “printed”, and “deletion” fields of the new information set, default values (“NO”, “NO”, and “NOT ALLOWED”) are registered. With the above configuration, the server 100 receives data including a print job and print area information from the information processing apparatus 500, temporarily stores the print job in a predetermined storage area, and registers the print area information in the management information 90D to associate the stored print job with the print area information.

The area management unit 12 also updates the management information 90D as described below.

The area management unit 12 receives job identification information from the print control apparatus 300 as a print job request. Based on the received job identification information, the area management unit 12 identifies a print job corresponding to the job identification information from the temporarily-stored print jobs. The area management unit 12 sends the identified print job to the print control apparatus 300 as a response to the print job request. Next, the area management unit 12 accesses the management information storing unit 90 and searches the management information 90D for an information set corresponding to the job identification information. Then, the area management unit 12 changes the value of the “obtained” field in the found information set from “NO” to “YES”.

After a print job is printed (or executed) at the image processing apparatus 400, the area management unit 12 receives the corresponding job identification information from the image processing apparatus 400 as a management information update request. Next, the area management unit 12 accesses the management information storing unit 90 and searches the management information 90D for an information set corresponding to the received job identification information. Then, the area management unit 12 changes the value of the “printed” field in the found information set from “NO” to “YES” and changes the value of the “deletion” field from “NOT ALLOWED” to “ALLOWED”.

When the value of the “obtained” field associated with the “area” field is changed to “YES”, the area management unit 12 deletes the temporarily-stored print job that is associated with the print area information in the “area” field. Here, an information set in the management information 90D may include plural “area” fields associated with the same “job identification” field and plural “obtained” fields for the respective “area” fields. In this case, the area management unit 12 deletes the print job when the values of all the “obtained” fields associated with the “area” fields are changed to “YES”.

Further, the area management unit 12 generates a job list for a print area as described below.

The area management unit 12 receives installation area information from the print control apparatus 300 as a query about print jobs. The installation area information is, for example, an identifier for uniquely identifying an area (installation area) where the print control apparatus 300 is installed (or located). The area management unit 12 accesses the management information storing unit 90 and searches the management information 90D to find information sets including print area information (a value in the “area” field) corresponding to the installation area information. Then, the area management unit 12 generates a job list including the found information sets and sends the job list to the print control apparatus 300 as a response to the query. In other words, the server 100 returns a job list of print jobs associated with a print area corresponding to the installation area of the print control apparatus 300 sending the query.

### <Authentication Apparatus>

The authentication unit 21 is a functional unit that performs user authentication. The authentication unit 21 performs user authentication based on user information sent as an authentication request from the information processing apparatus 500 or the image processing apparatus 400. Based on user identification information in the user information, the authentication unit 21 refers to authentication information that is stored for each user in a storage area of a storage unit of the authentication apparatus 200. The authentication unit 21 determines whether authentication information in the user information matches the authentication information in the storage area and thereby performs user authentication. Then, the authentication unit 21 sends the result of the user authentication to the information processing apparatus 500 or the image processing apparatus 400 as a response to the authentication request.

### <Print Control Apparatus>

The server query unit 31 is a functional unit that queries the area management unit 12 of the server 100 about print jobs. The server query unit 31 sends the installation area information to the server 100 to query about print jobs. As a response from the server 100, the server query unit 31 receives a job list (i.e., a list of information sets) of print jobs that are temporarily stored in the server 100 in association with print area information corresponding to the installation area information of the print control apparatus 300.

The server query unit 31 refers to the received job list and determines, based on acquisition status information, whether there are print jobs to be obtained (i.e., print jobs that have not been obtained yet). More specifically, the server query unit 31 refers to the “obtained” field in each information set in the job list, and if the value of the “obtained” field is “NO”, the server query unit 31 determines that the print job corresponding to the information set needs to be obtained from the server 100. When it is determined that there is a print job to be obtained from the server 100, the server query unit 31 sends the job identification information in the corresponding information set to the area management unit 12 of the server 100 to request the print job. As described above, in the present embodiment, data communications between the print control apparatus 300 and the server 100 are performed only when there are print jobs to be obtained. This configuration makes it possible to reduce the communication load.

When a print job is received from the server 100, the server query unit 31 inputs the received print job and the corresponding information set (i.e., the corresponding management information) to the print job management unit 32 to request the print job management unit 32 to store the print job.

Also, the server query unit 31 refers to the received job list and determines, based on deletion control information, whether there are print jobs to be deleted (i.e., print jobs that can be deleted). More specifically, the server query unit 31 refers to the “deletion” field in each information set in the job list, and if the value of the “deletion” field is “ALLOWED”, the server query unit 31 determines that the print job corresponding to the information set needs to be deleted from the print control apparatus 300. When it is determined that there is a print job to be deleted from the print control apparatus 300, the server query unit 31 inputs the job identification information in the corresponding information set to the print job management unit 32 to request deletion of the print job.

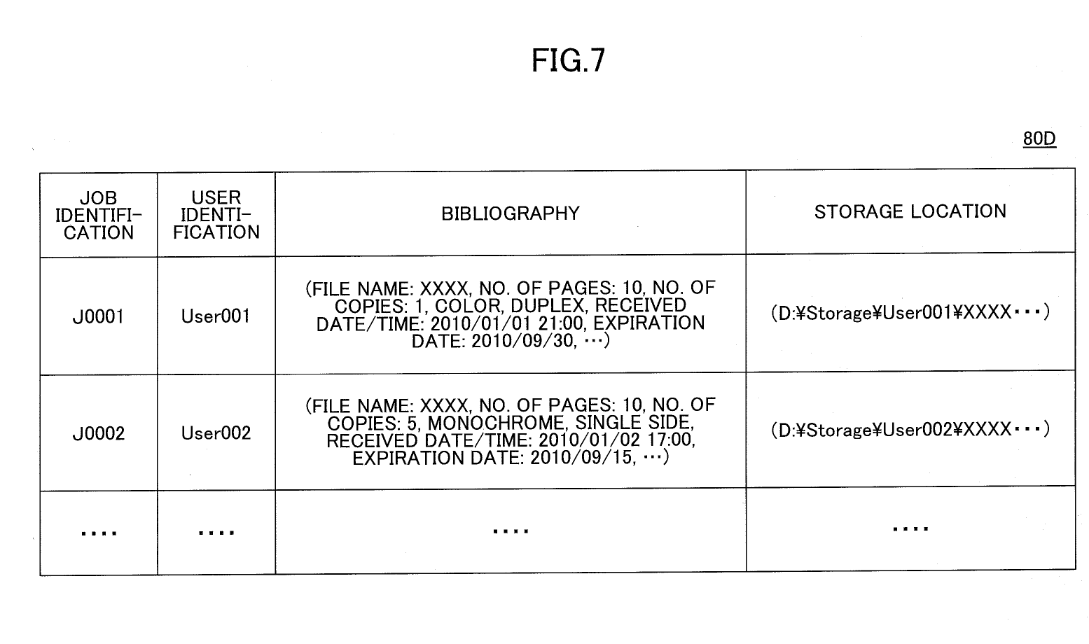

The print job management unit 32 is a functional unit that manages print jobs. The print job management unit 32 stores print jobs received from the area management unit 12 of the server 100 in a predetermined storage area of a storage unit of the print control apparatus 300, and manages the stored print jobs using print job information 80D as illustrated in FIG. 7.

The print job information 80D is described below.

FIG. 7 is a table illustrating an example of the print job information 80D.

As illustrated in FIG. 7, the print job information 80D may include an information set for each print job. The information set may include “job identification”, “user identification”, “bibliography”, and “storage location” fields that are associated with each other.

The “job identification” field stores job identification information. The “user identification” field stores user identification information. The “bibliography” field stores bibliographic information. The “storage location” field stores information (storage location information) indicating a location where a print job is stored. The storage location information may be represented, for example, by an access path or a data path (e.g., a file path) to the print job.

The print job information 80D is stored and retained in a print job information storing unit 80 that is implemented by a storage area of a storage unit of the print control apparatus 300.

Referring again to FIG. 3, the print job management unit 32 registers the print job information 80D as described below.

When receiving the management information 90D (i.e., an information set) corresponding to an obtained print job from the server query unit 31, the print job management unit 32 accesses the print job information storing unit 80, generates a new information set based on the received management information 90D, and registers the generated information set in the print job information 80D. More specifically, the print job management unit 32 generates a new information set by registering the job identification information, the user identification information, and the bibliographic information obtained from the received management information 90D in the “job identification”, “user identification”, and “bibliography” fields. In the “storage location” field of the information set, an access path or a data path to the stored print job is registered. With the above configuration, the print control apparatus 300 receives print jobs from the server 100, stores the print jobs, records storage location information in the print job information 80D, and thereby manages the stored print jobs.

The print job management unit 32 also updates or deletes information sets in the print job information 80D as described below.

The print job management unit 32 receives job identification information from the server query unit 31 as a request to delete the corresponding information set. The print job management unit 32 accesses the print job information storing unit 80 and searches the print job information 80D to find an information set corresponding to the job identification information. The print job management unit 32 deletes the found information set.

Further, the print job management unit 32 generates a job list for a user as described below.

The print job management unit 32 receives user identification information from the image processing apparatus 400 requesting a job list for the user. The print job management unit 32 accesses the print job information storing unit 80 and searches the print job information 80D to find information sets corresponding to the received user identification information. Then, the print job management unit 32 generates a job list including the found information sets and the corresponding print jobs of the user, and sends the job list to the image processing apparatus 400 as a response to the request. In generating the job list, the print job management unit 32 identifies the print jobs based on the storage location information in the found information sets.

### <Image Processing Apparatus>

The authentication requesting unit 41 is a functional unit that requests user authentication. The authentication requesting unit 41, for example, displays the log-in screen W1 as illustrated in FIG. 4 to receive user information. The authentication requesting unit 41 sends the received user information to the authentication apparatus 200 to request user authentication. Then, the authentication requesting unit 41 receives an authentication result from the authentication apparatus 200 and determines whether the user is an authorized user based on the authentication result.

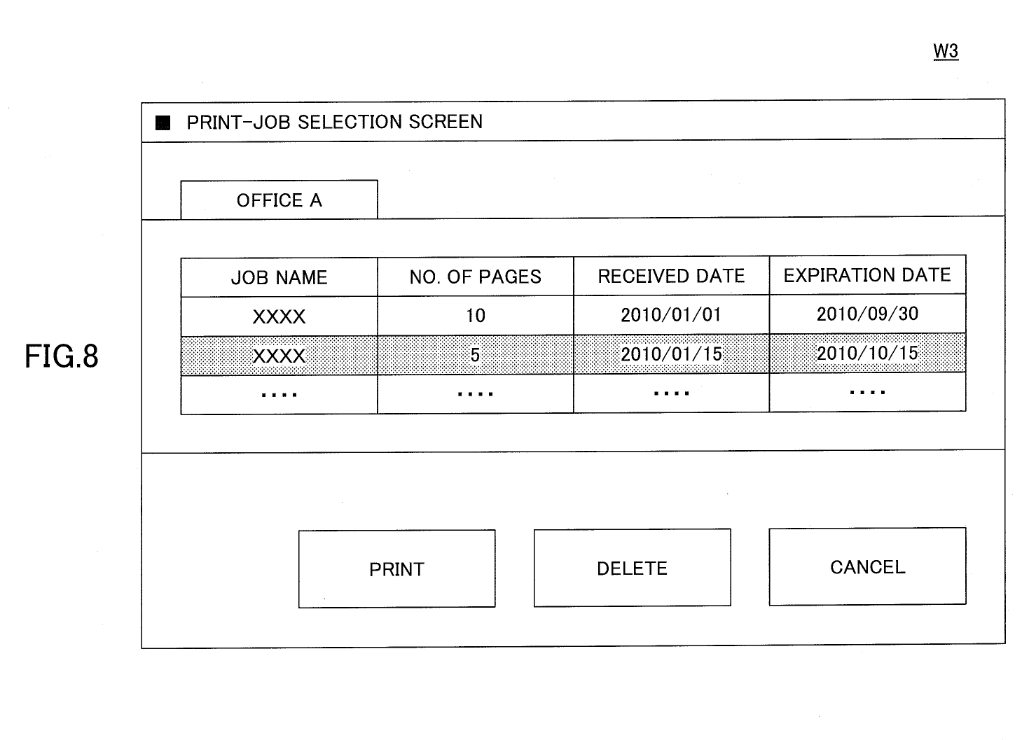

The print control unit 42 is a functional unit that controls printing. When the user is an authorized user, the print control unit 42 sends the user identification information of the user to the print job management unit 32 of the print control apparatus 300 to request a job list for the user. As a response from the print control apparatus 300, the print control unit 42 receives a job list and displays, for example, a print job selection screen W3 as illustrated in FIG. 8.

FIG. 8 is a drawing illustrating an example of the print job selection screen W3.

As illustrated in FIG. 8, the print job selection screen W3 allows the user to select a print job. The print control unit 42 receives information on the selected print job via the print job selection screen W3, and searches the received job list to identify the selected print job and print conditions in the bibliographic information in the information set corresponding to the selected print job.

Referring again to FIG. 3, the print control unit 42 inputs the identified print job to a plotter (not shown) of the image processing apparatus 400 and performs printing according to the identified print conditions. After printing, the print control unit 42 sends the job identification information of the print job to the area management unit 12 of the server 100 to request the area management unit 12 to update the management information 90D (or an information set) corresponding to the print job.

As described above, the print control function of the present embodiment is provided through collaboration among the functional units. The above functional units are implemented by executing programs (software for implementing the print control function) installed in the respective apparatuses constituting the print control system 1. For example, in each apparatus, the programs are loaded by a processor (e.g., CPU) from a storage unit (e.g., ROM or HDD) into a memory (e.g., RAM) and are executed to implement the corresponding functional units.

Exemplary print control processes (collaboration among functional units) are described below with reference to sequence charts.

### <Process of Temporarily Storing Print Job>

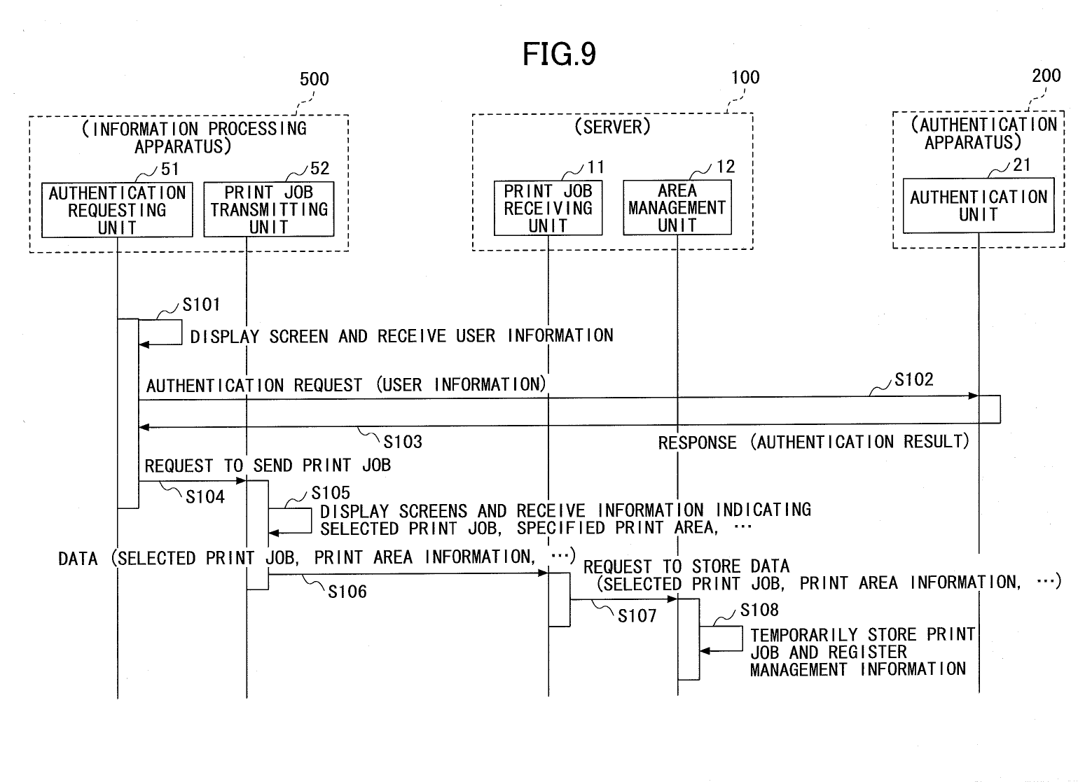

FIG. 9 is a sequence chart illustrating an exemplary print control process (1).

As illustrated in FIG. 9, the authentication requesting unit 51 of the information processing apparatus 500 displays the log-in screen W1 and receives user information via the log-in screen W1 (step S101).

When receiving the user information, the authentication requesting unit 51 of the information processing apparatus 100 sends the user information to the authentication unit 21 of the authentication apparatus 200 as an authentication request to request user authentication (step S102).

When receiving the user information, the authentication unit 21 of the authentication apparatus 200 performs user authentication based on the received user information and sends an authentication result to the authentication requesting unit 51 of the information processing apparatus 500 as a response to the authentication request (step S103).

When receiving the authentication result, the authentication requesting unit 51 of the information processing apparatus 500 determines whether the user is an authorized user based on the received authentication result. When the user is an authorized user, the authentication requesting unit 51 requests the print job transmitting unit 52 to send a print job (step S104).

The print job transmitting unit 52 of the information processing apparatus 500 displays, for example, an operation screen allowing the user to select a print job and the print area specification screen W2 allowing the user to specify a print area, and thereby receives information indicating the selected print job and the specified print area (step S105).

When receiving the information, the print job transmitting unit 52 of the information processing apparatus 500 sends data including the selected print job and print area information indicating the specified print area to the server 100 (step S106). When sending the print job and the print area information, the print job transmitting unit 52 may also send the user identification information of the authorized user, the job identification information of the print job, and bibliographic information obtained from print conditions set in the print job.

When receiving the data, the print job receiving unit 11 of the server 100 inputs the data including the print job and the print area information to the area management unit 12 and requests the area management unit 12 to store the data (step S107).

The area management unit 12 of the server 100 temporarily stores the print job in a predetermined storage area and registers, in the management information 90D, an information set for the print job based on the received data including the print area information (step S108). More specifically, the area management unit 12 accesses the management information storing unit 90 and registers a new information set including the user identification information, the job identification information, the bibliographic information, and the print area information received from the information processing apparatus 500 in the management information 90D. Also, default values are registered for the acquisition status information, the print status information, and the deletion control information in the information set.

Thus, the server 100 receives data including a print job and print area information specified for the print job from the information processing apparatus 500, temporarily stores the print job in a predetermined storage area, and manages the print job in association with the print area information.

### <Process of Obtaining Print Job>

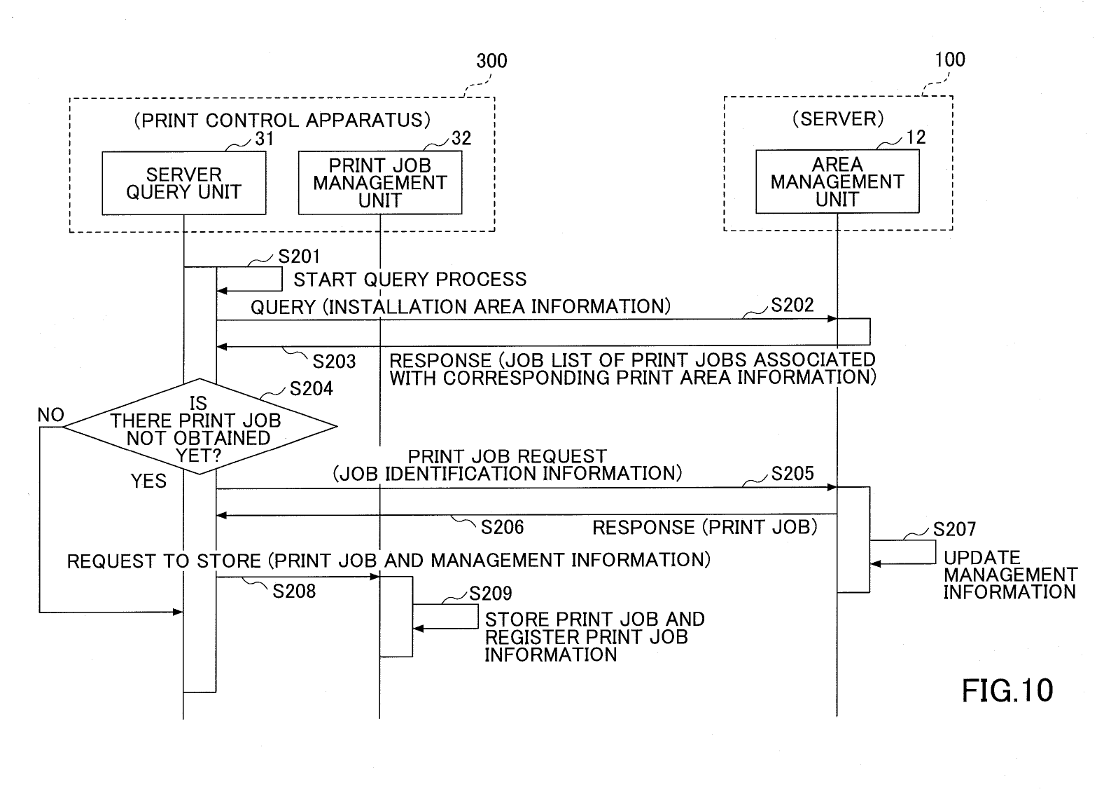

FIG. 10 is a sequence chart illustrating an exemplary print control process (2).

As illustrated in FIG. 10, the server query unit 31 of the print control apparatus 300 starts a query process for querying the server 100 about print jobs (step S201). The query process may be started according to a predetermined schedule (e.g., at predetermined intervals or after a predetermined period of time).

After starting the query process, the server query unit 31 of the print control apparatus 300 sends installation area information to the area management unit of the server 100 to query about print jobs (step S202).

When receiving the installation area information, the area management unit 12 of the server 100 generates a job list of print jobs temporarily stored in association with print area information corresponding to the received installation area information, and sends the job list to the server query unit 31 of the print control apparatus 300 as a response to the query (step S203). In this step, the area management unit 12 accesses the management information storing unit 90 and searches the management information 90D to find information sets including the print area information corresponding to the installation area information. Then, the area management unit 12 generates a job list including the found information sets of the management information 90D. In other words, the area management unit 12 generates a job list of print jobs associated with a print area corresponding to the installation area of the print control apparatus 300 sending the query.

When receiving the job list, the server query unit 31 of the print control apparatus 300 refers to the received job list and determines whether there is a print job(s) to be obtained (i.e., print jobs that have not been obtained) based on the acquisition status information (step S204). More specifically, the server query unit 31 refers to the acquisition status information (in the “obtained” field) in each information set included in the job list, and if the value of the acquisition status information is “NO”, the server query unit 31 determines that the print job corresponding to the information set needs to be obtained from the server 100.

When it is determined that there is a print job to be obtained from the server 100 (YES in step S204), the server query unit 31 of the print control apparatus 300 sends job identification information of the print job to the area management unit 12 of the server 100 as a print job request to request the print job (step S205).

When receiving the job identification information, the area management unit 12 of the server 100 identifies the corresponding print job in the temporarily stored print jobs based on the received job identification information, and sends the identified print job to the server query unit 31 of the print control apparatus 300 as a response to the print job request (step S206).

Also, the area management unit 12 of the server 100 accesses the management information storing unit 90, searches the management information 90D to find an information set corresponding to the job identification information, and updates the acquisition status information (the “obtained” field) in the found information set to “YES” (step S207).

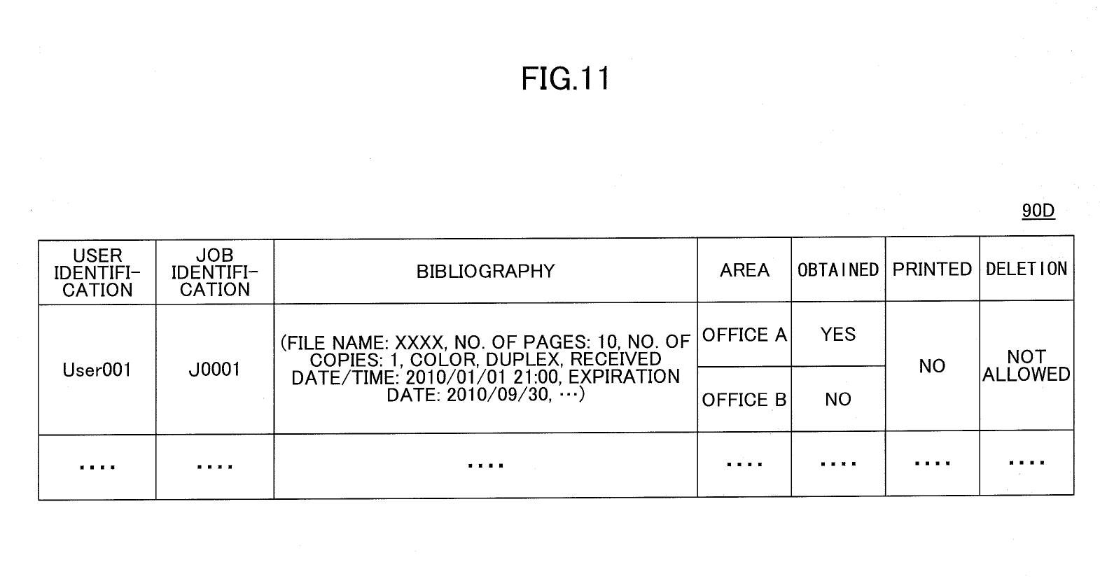

FIG. 11 is a table illustrating an exemplary change (1) made to the management information 90D.

In FIG. 11, it is assumed that the print control apparatus 300 is installed in office A. In this example, the value of the acquisition status information (the “obtained” field) corresponding to the print area information “office A” has been changed from “NO” to “YES” because the corresponding print job has been obtained from the server 100 by the print control apparatus 300.

When the value of the acquisition status information associated with the print area information is changed to “YES”, the server 100 deletes the print job temporarily stored in association with the print area information.

Referring back to FIG. 10, when receiving the print job, the server query unit 31 of the print control apparatus 300 inputs the received print job and the corresponding information set of the management information 90D to the print job management unit 32, and requests the print job management unit 32 to store the print job (step S208).

The print job management unit 32 of the print control apparatus 300 stores the print job in a predetermined storage area and registers an information set corresponding to the print job in the print job information 80D based on the information set of the management information 90D (step S209). More specifically, the print job management unit 32 accesses the print job information storing unit 80 and registers, in the print job information 80D, a new information set including the job identification information, the user identification information, and the bibliographic information that are obtained from the information set of the management information 90D. Also, the access path or data path to the stored print job is registered as storage location information in the new information set of the print job information 80D.

Meanwhile, when it is determined that there is no print job to be obtained from the server 100 (NO in step S204), steps S205 through S209 are not performed.

Thus, the print control apparatus 300 obtains, from the server 100, not-yet-obtained print jobs associated with a print area corresponding to the installation area of the print control apparatus 300, stores the obtained print jobs in a predetermined storage area, and manages the stored print jobs using the print job information 80D.

### <Process of Printing Print Job>

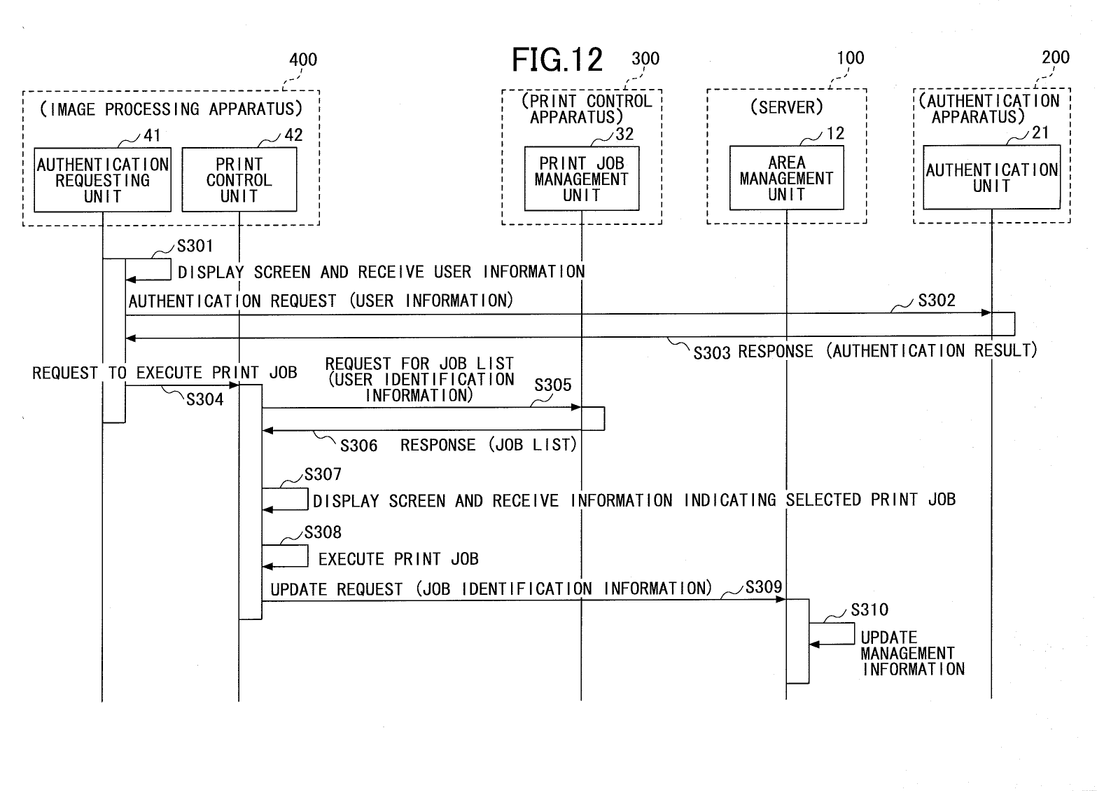

FIG. 12 is a sequence chart illustrating an exemplary print control process (3).

As illustrated in FIG. 12, the authentication requesting unit 41 of the image processing apparatus 400 displays the log-in screen W1 and receives user information via the log-in screen W1 (step S301).

When receiving the user information, the authentication requesting unit 41 of the image processing apparatus 400 sends the user information to the authentication unit 21 of the authentication apparatus 200 as an authentication request to request user authentication (step S302).

When receiving the user information, the authentication unit 21 of the authentication apparatus 200 performs user authentication based on the received user information and sends an authentication result to the authentication requesting unit 41 of the image processing apparatus 400 as a response to the authentication request (step S303).

When receiving the authentication result, the authentication requesting unit 41 of the image processing apparatus 400 determines whether the user is an authorized user based on the received authentication result. When the user is an authorized user, the authentication requesting unit 41 requests the print control unit 42 to execute a print job (step S304).

The print control unit 42 of the image processing apparatus 400 sends the user identification information of the user to the print job management unit 32 of the print control apparatus 300 to request a job list for the user (step S305).

When receiving the user identification information, the print job management unit 32 of the print control apparatus 300 generates a job list of print jobs stored in association with the received user identification information, and sends the generated job list to the print control unit 42 of the image processing apparatus 400 as a response to the request (step S306). More specifically, the print job management unit 32 accesses the print job information storing unit 80 and searches the print job information 80D to find information sets corresponding to the received user identification information. Then, the print job management unit 32 generates a job list including the found information sets and the corresponding print jobs of the user. In generating the job list, the print job management unit 32 identifies the print jobs based on the storage location information in the found information sets. In other words, the print job management unit 32 generates a job list including print jobs that are owned by the authorized user.

When receiving the job list, the print control unit 42 of the image processing apparatus 400 displays the print job selection screen W3 based on the received job list to allow the user to select a print job, and thereby receives information on the selected print job (step S307). The print control unit 42 searches the received job list to identify the selected print job and print conditions in the bibliographic information in the information set (the print job information 80D) corresponding to the selected print job.

The print control unit 42 of the image processing apparatus 400 inputs the identified print job to a plotter (not shown) and executes the print job according to the identified print conditions (step S308).

After executing the print job, the print control unit 42 of the image processing apparatus 400 sends the job identification information of the executed print job to the area management unit 12 of the server 100 to request the area management unit 12 to update the management information 90D (i.e., an information set) corresponding to the print job (step S309).

When receiving the job identification information, the area management unit 12 of the server 100 accesses the management information storing unit 90, searches the management information 90D based on the received job identification information to find an information set corresponding to the job identification information, updates the print status information in the found information set to “YES”, and updates the deletion control information to “ALLOWED” (step S310).

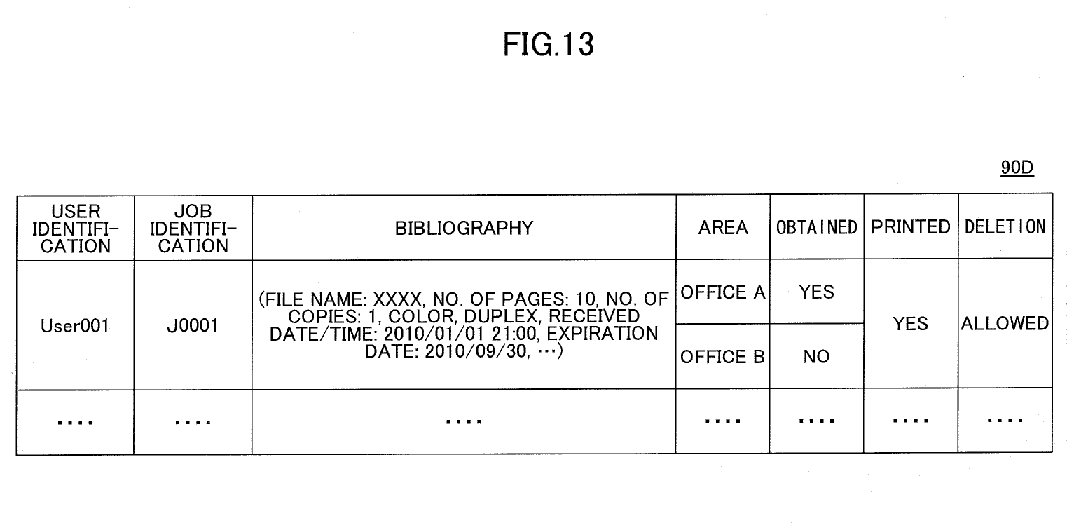

FIG. 13 is a table illustrating an exemplary change (2) made to the management information 90D.

In FIG. 13, it is assumed that a print job with the job identification information “J0001” has been printed (or executed). In this example, the value of the print status information corresponding to the job identification information “J0001” has been changed from “NO” to “YES”. Also, the value of the deletion control information corresponding to the job identification information “J0001” has been changed from “NOT ALLOWED” to “ALLOWED”.

Thus, the image processing apparatus 400 receives print jobs from the print control apparatus 300 and executes a print job selected by the user from the received print jobs. Then, according to a request from the image processing apparatus 400, the server 100 updates an information set in the management information 90D corresponding to the executed print job to indicate that the print job has been executed.

### <Process of Updating Management Information After Printing>

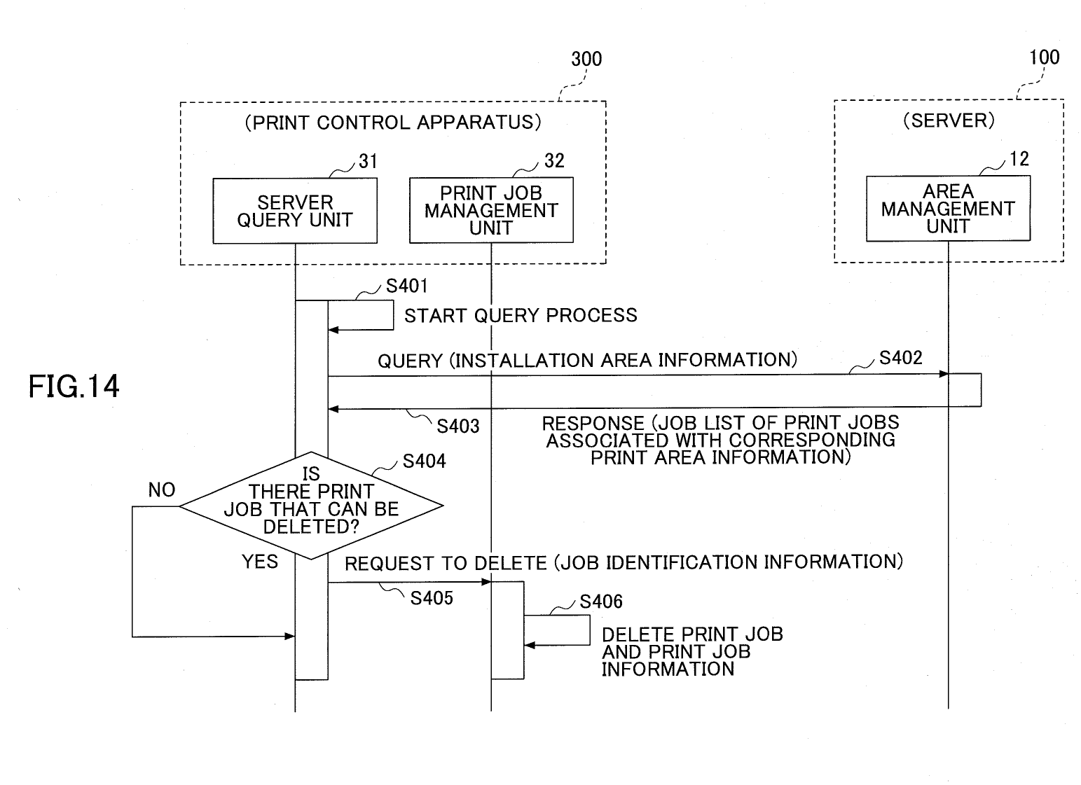

FIG. 14 is a sequence chart illustrating an exemplary print control process (4). Steps S401 through S403 of FIG. 14 are substantially the same as steps S201 through S203 of FIG. 10. Therefore, only short descriptions are provided below for steps S401 through S403.

As illustrated in FIG. 14, the server query unit 31 of the print control apparatus 300 starts a query process for querying the server 100 about print jobs (step S401).

After starting the query process, the server query unit 31 of the print control apparatus 300 sends installation area information to the area management unit of the server 100 to query about print jobs (step S402).

When receiving the installation area information, the area management unit 12 of the server 100 generates a job list of print jobs temporarily stored in association with print area information corresponding to the received installation area information, and sends the job list to the server query unit 31 of the print control apparatus 300 as a response to the query (step S403).

When receiving the job list, the server query unit 31 of the print control apparatus 300 refers to the received job list and determines whether there is a print job(s) to be deleted (i.e., a print job that can be deleted) based on the deletion control information (step S404). More specifically, the server query unit 31 refers to the deletion control information (in the “deletion” field) in each information set included in the job list, and if the value of the deletion control information is “ALLOWED”, the server query unit 31 determines that the print job corresponding to the information set needs to be deleted.

When it is determined that there is a print job to be deleted from the print control apparatus 300 (YES in step S404), the server query unit 31 inputs the job identification information in the corresponding information set to the print job management unit 32 to request deletion of the print job (step S405).

The print job management unit 32 of the print control apparatus 300 deletes the print job corresponding to the job identification information from the storage area, and deletes the information set corresponding to the deleted print job from the print job information 80D (step S406). More specifically, the print job management unit 32 accesses the print job information storing unit 80, searches the print job information 80D based on the job identification information to find the corresponding information set, and deletes the found information set.

Meanwhile, when it is determined that there is no print job to be deleted from the print control apparatus 300 (NO in step S404), steps S405 and S406 are not performed.

Thus, the print control apparatus 300 deletes a print job stored in its storage area when the value of the deletion control information of the print job is changed to “ALLOWED” at the server 100, and also deletes the information set in the print job information 80D corresponding to the deleted print job.

The processes of FIGS. 10 and 14 are separately described above to make it easier to understand steps S204 and S404 and the steps performed based on the decisions at steps S204 and S404. However, the processes of FIGS. 10 and 14 are not necessarily performed at different timings, and may be performed concurrently or at the same timing.

### <Summary>

As described above, in the print control system 1 of the present embodiment, the server 100 is connected to the external network I that is accessible to external apparatuses. The area management unit 12 of the server 100 temporarily stores print jobs, which are sent from the information processing apparatuses 500 that cannot access (or are not allowed to connect to) the print control apparatus 300, in a predetermined storage area, and manages the stored print jobs in association with print area information indicating areas where users desire to print (or execute) the print jobs. The print area information is specified by the respective users when sending the print jobs.

In the environment described above, the server query unit 31 of the print control apparatus 300 sends installation area information indicating an area where the print control apparatus 300 is installed (or located) to the server 100 and thereby requests print jobs from the server 100. Then, the server query unit 31 of the print control apparatus 300 obtains, from the server 100, print jobs associated with print area information corresponding to the installation area information. The print job management unit 32 of the print control apparatus 300 stores the obtained print jobs in a predetermined storage area.

This configuration enables the image processing apparatuses 400 that can access the print control apparatus 300 to print (or execute) print jobs obtained from the print control apparatus 300.

In other words, the print control system 1 of the present embodiment provides an environment where the information processing apparatuses 500 can use a printing service of the print control apparatus 300 that the information processing apparatuses 500 are not allowed to access.

The print control function of the above embodiment may be implemented, for example, by executing a program, which is written in a programming language supported by the operating environment (platform) of the respective apparatuses (such as the server 100, the authentication apparatus 200, the print control apparatus 300, the image processing apparatuses 400, and the information processing apparatuses 500) constituting the print control system 1, by a processor (e.g., a CPU) of the respective apparatuses.

Such a program may be stored in a non-transitory computer-readable storage medium (e.g., the storage medium 103a) such as a floppy (flexible) disk (FD), a compact disk (CD), a digital versatile disk (DVD), a secure digital (SD) memory card, or a universal serial bus (USB) memory. For example, the program stored in the storage medium 103a may be installed in the server 100 via the external I/F 103. Alternatively, the program may be downloaded and installed via a telecommunication line and the communication I/F 107 into the server 100.

In the above embodiment, the server 100 and the authentication apparatus 200 are provided separately. Alternatively, the functions of the server 100 and the authentication apparatus 200 may be combined. For example, the server 100 may include an authentication function and the authentication apparatus 200 may be omitted.

In the above embodiment, the information processing apparatus 500 is configured to display the print area specification screen W2 that allows the user to specify a print area. Information on candidates of print areas to be displayed on the print area specification screen W2 may be stored either in the information processing apparatus 500 or the server 100. When the server 100 stores the information on candidates of print areas, the information processing apparatus 500 may be configured to obtain the information from the server 100 and display the print area specification screen W2 based on the obtained information.

A server, a print control system, and a print control method are described above as preferred embodiments. However, the present invention is not limited to the specifically disclosed embodiments, and variations and modifications may be made without departing from the scope of the present invention.

An aspect of this disclosure provides a server, a print control system, a print control method, and a storage medium storing a program that enable an external apparatus to use a printing service of a print control apparatus that the external apparatus is not allowed to access. However, the present invention may also be applied to an apparatus, a system, and a method for controlling and managing jobs other than print jobs. In this sense, the server 100 may be referred to as a job management apparatus, the print control apparatus 300 may be referred to as a job control apparatus, and the image processing apparatus 400 may be referred to as an execution apparatus.

What is claimed is:

1. A job management apparatus, comprising:
a communication unit configured to connect the job management apparatus via an external network to a job control apparatus in a first network and an information processing apparatus in a second network that is different from the first network, the job control apparatus being configured to send a job to an execution apparatus that is in the first network and executes the job;
a receiving unit configured to receive jobs from the information processing apparatus; and
a management unit configured to
temporarily store the received jobs in a storage area in association with execution areas where the jobs are to be executed, and
send, to the job control apparatus, one or more of the jobs associated with an execution area corresponding to an installation area where the job control apparatus is installed in response to a request from the job control apparatus.

2. The job management apparatus as claimed in claim 1, further comprising:
a storing unit configured to store management information for managing the execution areas, wherein
the receiving unit is configured to receive, from the information processing apparatus, data including the jobs and execution area information indicating the execution areas; and
the management unit is configured to register job identification information of the jobs in the management information in association with the execution area information.

3. The job management apparatus as claimed in claim 2, wherein
when a query including installation area information indicating the installation area is received from the job control apparatus, the management unit searches the management information based on the installation area information and sends, to the job control apparatus, a job list including the job identification information of the jobs associated with the execution area information that corresponds to the installation area information; and
when the job identification information of one or more of the jobs in the job list is received from the job control apparatus, the management unit sends the jobs corresponding to the received job identification information to the job control apparatus.

4. A job control system, comprising:
a job control apparatus connected to a first network and configured to send a job to an execution apparatus that is in the first network and executes the job;
an information processing apparatus in a second network that is different from the first network; and
a job management apparatus connected via an external network to the job control apparatus and the information processing apparatus, wherein
the job management apparatus includes
a receiving unit configured to receive jobs from the information processing apparatus, and
a management unit configured to temporarily store the received jobs in a storage area in association with execution areas where the jobs are to be executed;
the job control apparatus includes
a query unit configured to send a request to the job management apparatus to obtain one or more of the jobs, and
a job storing unit configured to store the obtained jobs; and
the management unit is configured to send, to the job control apparatus, one or more of the jobs associated with an execution area corresponding to an installation area where the job control apparatus is installed in response to the request from the job control apparatus.

5. The job control system as claimed in claim 4, wherein
the job management apparatus further includes a management information storing unit configured to store management information for managing the execution areas;
the receiving unit is configured to receive, from the information processing apparatus, data including the jobs and execution area information indicating the execution areas; and
the management unit is configured to register job identification information of the jobs in the management information in association with the execution area information.

6. The job control system as claimed in claim 5, wherein
the query unit is configured to send a query including installation area information indicating the installation area to the job management apparatus;
the management unit is configured to search the management information based on the installation area information and send, to the job control apparatus, a job list including the job identification information of the jobs associated with the execution area information that corresponds to the installation area information;
the query unit is further configured to
determine, based on the job list, whether there are jobs to be obtained from the job management apparatus, and
when there are jobs to be obtained, send the job identification information of the jobs to be obtained to the job management apparatus; and
the management unit is configured to receive the job identification information and send the jobs corresponding to the received job identification information to the job control apparatus.

7. The job control system as claimed in claim 6, wherein
after sending the jobs to the job control apparatus, the management unit searches the management information based on the job identification information of the sent jobs, and updates acquisition status information registered in the management information in association with the job identification information such that the acquisition status information indicates that the corresponding jobs have been obtained by the job control apparatus.

8. The job control system as claimed in claim 7, wherein
the job list includes the acquisition status information in addition to the job identification information of the jobs; and
the query unit is configured to
determine, based on the acquisition status information in the job list, whether there are jobs that have not been obtained from the job management apparatus, and
when there are jobs that have not been obtained, send the job identification information of the jobs that have not been obtained to the job management apparatus.

9. A method for a job control system that includes
a job control apparatus that is in a first network and sends a job to an execution apparatus that is in the first network and executes the job, an information processing apparatus in a second network that is different from the first network, and a job management apparatus connected via an external network to the job control apparatus and the information processing apparatus,
the method comprising:
receiving, by the job management apparatus, jobs from the information processing apparatus;
temporarily storing the received jobs in a storage area of the job management apparatus in association with execution areas where the jobs are to be executed;
sending a request from the job control apparatus to the job management apparatus to obtain one or more of the jobs;
sending, from the job management apparatus to the job control apparatus, one or more of the jobs associated with an execution area corresponding to an installation area where the job control apparatus is installed in response to the request from the job control apparatus; and
storing the jobs sent from the job management apparatus in a job storing unit of the job control apparatus.

10. The method as claimed in claim 9, further comprising:
receiving, by the job management apparatus, data including the jobs and execution area information indicating the execution areas from the information processing apparatus; and
registering job identification information of the jobs in association with the execution area information in management information stored in a management information storing unit of the job management apparatus.

11. The method as claimed in claim 10, further comprising:
sending, from the job control apparatus to the job management apparatus, a query including installation area information indicating the installation area;
searching the management information, by the job management apparatus, based on the installation area information;
sending, from the job management apparatus to the job control apparatus, a job list including the job identification information of the jobs associated with the execution area information that corresponds to the installation area information;
determining, by the job control apparatus, whether there are jobs to be obtained from the job management apparatus based on the job list;
when there are jobs to be obtained, sending the job identification information of the jobs to be obtained from the job control apparatus to the job management apparatus; and
receiving the job identification information by the job management apparatus and sending the jobs corresponding to the received job identification information from the job management apparatus to the job control apparatus.

12. The method as claimed in claim 11, further comprising:
after sending the jobs to the job control apparatus, searching the management information, by the job management apparatus, based on the job identification information of the sent jobs; and
updating, by the job management apparatus, acquisition status information registered in the management information in association with the job identification information such that the acquisition status information indicates that the corresponding jobs have been obtained by the job control apparatus.

13. The method as claimed in claim 12, wherein the job list includes the acquisition status information in addition to the job identification information of the jobs, the method further comprising:
determining, by the job control apparatus, whether there are jobs that have not been obtained from the job management apparatus based on the acquisition status information in the job list; and
when there are jobs that have not been obtained, sending the job identification information of the jobs that have not been obtained from the job control apparatus to the job management apparatus.
